(19) United States
(12) Patent Application Publication
(10) Pub. No.: US 2007/0103789 A1
(43) Pub. Date: May 10, 2007

(54) Optical system, lithographic apparatus and method for projecting

(75) Inventor: Heine Melle Mulder, Veldhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., De Run (NL)

(21) Appl. No.: 11/270,825

(22) Filed: Nov. 10, 2005

(51) Int. Cl. G02B 3/00

(52) U.S. Cl. 359/649

(57) ABSTRACT

An optical system is configured to process a radiation beam along an optical axis. The optical system includes an optical element. The optical system defines a numerical aperture, the numerical aperture being a measure of the ability of the optical system to gather and focus light. The numerical aperture has a first value in a first direction and a second value in a second direction differing from the first direction, the first direction and the second direction being substantially perpendicular to the optical axis and the first and second values being different.

### FIELD OF THE INVENTION

The present invention relates to an optical system, a lithographic apparatus and a method for projecting.

### DESCRIPTION OF THE RELATED ART

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at one time, and scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

### SUMMARY OF THE INVENTION

According to an embodiment of the present invention, an optical system is configured to process a radiation beam along an optical axis, the optical system including an optical element, the optical system defining a numerical aperture, the numerical aperture being a measure of the ability of the optical system to gather and focus light, wherein the numerical aperture has a first value in a first direction and a second value in a second direction differing from the first direction, the first direction and the second direction being substantially perpendicular to the optical axis, and the first and second values being different.

According to another embodiment of the present invention, a lithographic apparatus includes an illumination system configured to condition a radiation beam; a support configured to support a patterning device, the patterning device being configured to impart the radiation beam with a pattern in its cross-section to form a patterned radiation beam; a substrate table configured to hold a substrate; and a projection system configured to project the patterned radiation beam onto a target portion of the substrate, wherein the projection system is an optical system being configured to process the radiation beam along an optical axis, the optical system comprising an optical element, the optical system defining a numerical aperture, the numerical aperture being a measure of the ability of the optical system to gather and focus light, the numerical aperture has a first value in a first direction and a second value in a second direction differing from the first direction, the first direction and the second direction being substantially perpendicular to the optical axis, and the first and second values being different.

According to a still further embodiment of the present invention, a lithographic apparatus includes an illumination system configured to condition a radiation beam; a support configured to support a patterning device, the patterning device being configured to impart the radiation beam with a pattern in its cross-section to form a patterned radiation beam; a substrate table configured to hold a substrate; and a projection system configured to project the patterned radiation beam onto a target portion of the substrate, wherein the illumination system is an optical system being configured to process the radiation beam along an optical axis, the optical system comprising an optical element, the optical system defining a numerical aperture, the numerical aperture being a measure of the ability of the optical system to gather and focus light, the numerical aperture has a first value in a first direction and a second value in a second direction differing from the first direction, the first direction and the second direction being substantially perpendicular to the optical axis, and the first and second values being different.

According to an even further embodiment of the present invention, a lithographic projection apparatus is arranged to project a pattern from a patterning device onto a substrate, wherein the lithographic projection apparatus includes an optical system being configured to process a radiation beam along an optical axis, the optical system comprising an optical element, the optical system defining a numerical aperture, the numerical aperture being a measure of the ability of the optical system to gather and focus light, the numerical aperture has a first value in a first direction and a second value in a second direction differing from the first direction, the first direction and the second direction being substantially perpendicular to the optical axis, and the first and second values being different.

According to yet another embodiment of the present invention, an apparatus includes an optical system being configured to process a radiation beam along an optical axis, the optical system comprising an optical element, the optical system defining a numerical aperture, the numerical aperture being a measure of the ability of the optical system to gather and focus light, wherein the numerical aperture has a first value in a first direction and a second value in a second direction differing from the first direction, the first direction and the second direction being substantially perpendicular to the optical axis, and the first and second values being different.

According to a further embodiment of the present invention, a method for projecting a pattern onto a target includes providing a beam of radiation; patterning the beam of radiation; projecting the patterned beam of radiation onto the target using a projection system having an optical axis, the projection system comprising an optical element and the projection system defining a numerical aperture, the numerical aperture being a measure of the ability of the projection system to gather and focus light and having a first value in a first direction and a second value in a second direction, the second direction differing from the first direction, the first direction and the second direction being substantially perpendicular to the optical axis, and the first and second values being different.

According to a still further embodiment of the present invention, a method for projecting a pattern onto a target includes providing a beam of radiation along an optical axis using an illuminator, the illuminator comprising an optical element and the illuminator defining a numerical aperture, the numerical aperture being a measure of the ability of the illuminator to gather and focus light and having a first value in a first direction and a second value in a second direction, the second direction differing from the first direction, the first direction and the second direction being substantially perpendicular to the optical axis, and the first and second values being different; patterning the beam of radiation; projecting the patterned beam onto the target.

According to yet another embodiment of the present invention, an optical system is configured to process a radiation beam along an optical axis, the optical system includes an optical element, wherein the optical element has a first dimension in a first direction and a second dimension in a second direction differing from the first direction, the first direction and the second direction being substantially perpendicular to the optical axis.

### BRIEF DESCRIPTION OF THE DRAWINGS

Embodiments of the present invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 schematically depicts a projection system according to the state of the art;

FIG. 3 schematically depicts a projection system according to an embodiment of the invention;

FIGS. 4a and 4b schematically depict a projection system according to an other embodiment of the invention; and

FIGS. 5a, 5b and 5c schematically depict further alternative embodiments of the invention.

### DETAILED DESCRIPTION

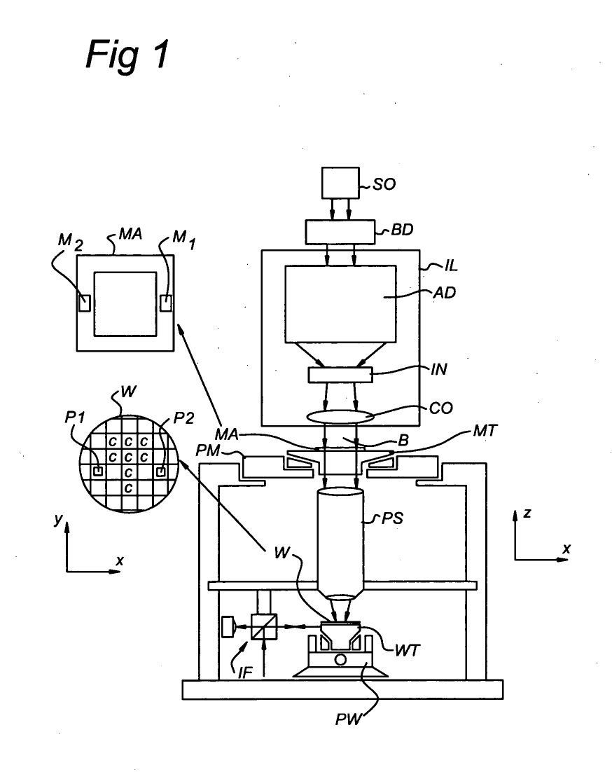

FIG. 1 schematically depicts a lithographic apparatus according to one embodiment of the invention. The apparatus includes an illumination system (illuminator) IL configured to condition a radiation beam B (e.g. UV radiation or EUV radiation). A support (e.g. a mask table) MT is configured to support a patterning device (e.g. a mask) MA and is connected to a first positioner PM configured to accurately position the patterning device in accordance with certain parameters. A substrate table (e.g. a wafer table) WT is configured to hold a substrate (e.g. a resist-coated wafer) W and is connected to a second positioner PW configured to accurately position the substrate in accordance with certain parameters. A projection system (e.g. a refractive projection lens system) PS is configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The support supports, e.g. bears the weight of, the patterning device. It holds the patterning device in a manner that depends on the orientation of the patterning device, the design of the lithographic apparatus, and other conditions, such as for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located, for example, between the projection system and the substrate during exposure.

Referring to FIG. 1, the illuminator IL receives radiation from a radiation source SO. The source and the lithographic apparatus may be separate entities, for example when the source is an excimer laser. In such cases, the source is not considered to form part of the lithographic apparatus and the radiation is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1 but which may also be, e.g., an interferometric device, linear encoder or capacitive sensor) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper, as opposed to a scanner, the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The projection system PS as described above is configured to project a pattern imparted to the radiation beam B by patterning device MA onto a target portion C (e.g. including one or more dies) of the substrate W. As already stated above, the projection system PS may include a plurality of elements, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

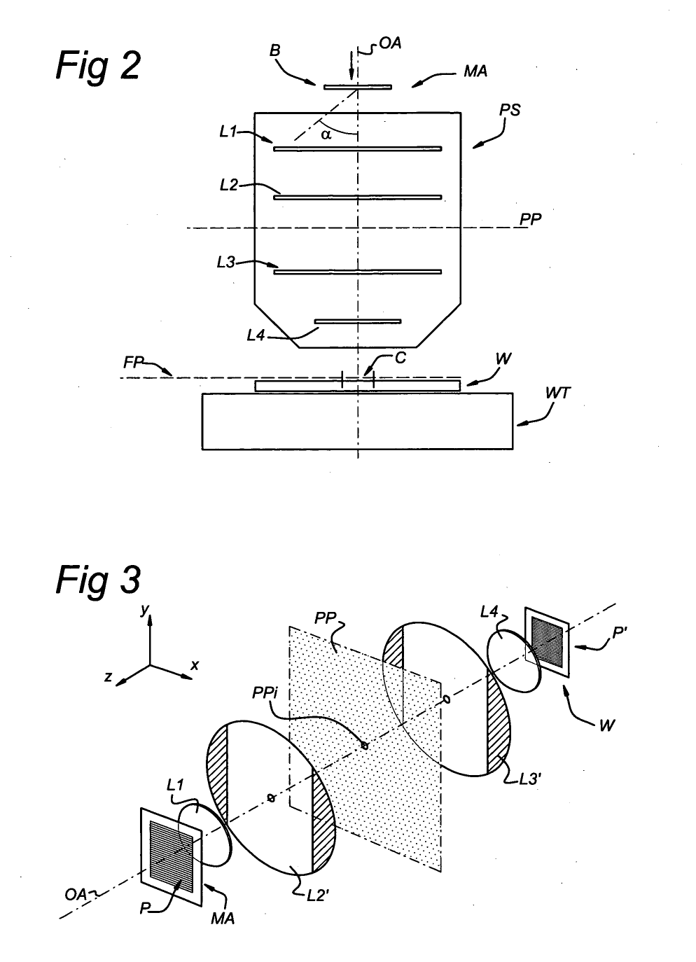

The smallest detail that can successfully be projected onto the target portion C, i.e. the maximal obtainable resolution, depends on the optical elements used and their mutual configuration. A well-known measure for the maximal obtainable resolution is the numerical aperture NA. The numerical aperture NA is a measure of the ability of a lens system or projection system to gather and focus light. The numerical aperture NA is defined as NA=n·sin α, where α is the maximum angle between a light beam as it emits from e.g. a mask MA and an optical axis, at which the light beam is still projected by the projection system PS and n is the refractive index of the medium the light is traveling through. Light that emits from the mask MA under an angle greater than α, is not projected by the projection system PS. A high numerical aperture NA is an indication of a projection system PS being capable, of projecting relative small details. This is further explained below, with reference to FIG. 2.

FIG. 2 schematically depicts a projection system PS arranged to project a pattern from mask MA onto substrate W using radiation beam B. The projection system PS depicted includes a number of optical elements: first lens L1, second lens L2, third lens L3 and fourth lens L4. Of course, any number of optical elements may be provided. The arrangement depicted in FIG. 2 is rotationally symmetrical about optical axis OA.

In FIG. 2 angle α is indicated, as it was used in the formula for the numerical aperture NA defined above: NA=n·sin α. It can clearly be seen that only light emitting from the mask MA having an angle equal to or less than a with respect to an optical axis OA, can be imaged by the projection system PS.

Projection system PS also has a pupil plane PP as indicated in FIG. 2 and will be understood by one of ordinary skill. In the pupil plane PP, the spatial information of the patterned radiation beam B is completely mixed.

The numerical aperture NA is determined by the hardware of the projection system PS. However, to what extent the numerical aperture NA is used, i.e. the filling of the numerical aperture NA, is determined by a number of factors, such as the pattern that is to be imaged, the illumination mode used, the wavelength of the radiation beam B. These factors determine to what extend the numerical aperture NA is used.

For example, in case an annular illumination mode or a dipole illumination mode is applied, the numerical aperture NA will not be fully used. Light associated with higher diffraction orders may partially fall without the numerical aperture NA. Diffraction orders that partially fall within the numerical aperture NA may not fill the numerical aperture NA completely.

To obtain the best projection result, the target portion C on substrate W should be accurately positioned with respect to the projection system PS, i.e. in a focal plane FP defined by the projection system PS. The further the target portion C is removed from the focal plane FP, the poorer the quality of the projected image. In the example shown in FIG. 2, the substrate W is positioned in the focal plane FP.

Another parameter describing the projection system PS is the depth of focus DOF. The depth of focus DOF is a parameter that is a measure for the distance in the direction of the optical axis OA the target portion C may be moved with respect to the focal plane FP, that is still acceptable, i.e. that still allows imaging of the smallest details of the projected pattern. The depth of focus DOF depends on the size of the smallest details that are to be projected.

It is known that a relatively high numerical aperture NA (allowing high resolution), implies a relatively low depth of focus DOF, and vice versa. It is known that DOF scales with λ/NA²: DOF ˜λ/NA², where λ is the wave length of the radiation beam B.

In order to obtain higher numerical apertures NA, the optical elements used in the projection system PS, such as lenses, are increasing in size. The material costs of these lenses (e.g. made of calcium-fluoride) form an increased part of the total costs of these lenses. Also, producing bigger lenses makes it more difficult to avoid or minimize stress in the lens material.

According to an embodiment of the present invention, a projection system PS is provided that has a numerical aperture NA that is not rotationally symmetric, but has different values for different directions. So, the numerical aperture NA in a first direction perpendicular to the optical axis OA is different from the numerical aperture NA in a second direction perpendicular to the optical axis OA. If, for example, the numerical aperture NA in the first direction is higher than the numerical aperture in the second direction, the quality of the imaged pattern is different in different directions: pattern structures extending in the first direction are imaged with a higher quality than pattern structures extending the second direction.

Such a projection system PS may, for example, be used in the lithographic production of memory devices, such as FLASH memory devices. Such memory devices are usually produced by projecting patterns that have a high resolution in the first direction, while having a relatively low resolution in the second direction, the second direction being substantially perpendicular to the first direction. Such patterns require a relatively high numerical aperture in the first direction, and a relatively low numerical aperture suffices in the second direction.

Also, a projection system PS having an asymmetrical numerical aperture NA may be used for research purposes. When testing resists, sensors used in lithographic projection apparatus, masks MA etc., in particular to see how they behave when imaging relatively small details, a projection system PS having an asymmetrical numerical aperture NA with a high numerical aperture NA in a first direction and a low, or virtually no, numerical aperture NA in a second direction may be used. This way, a projection system PS having a high numerical aperture NA could be configured to test high numerical aperture effects at an early stage in a cost efficient way.

Currently, two-beam interferometer setups are used to test resists, where two interfering beams are used to project a line pattern on the resist. However, only gratings with 50% duty cycle can be tested. Line patterns having another pitch (through pitch behavior etc.) cannot be tested using these tools. Also masks MA cannot be tested this way. A cost efficient projection system PS as described above takes away these limitations.

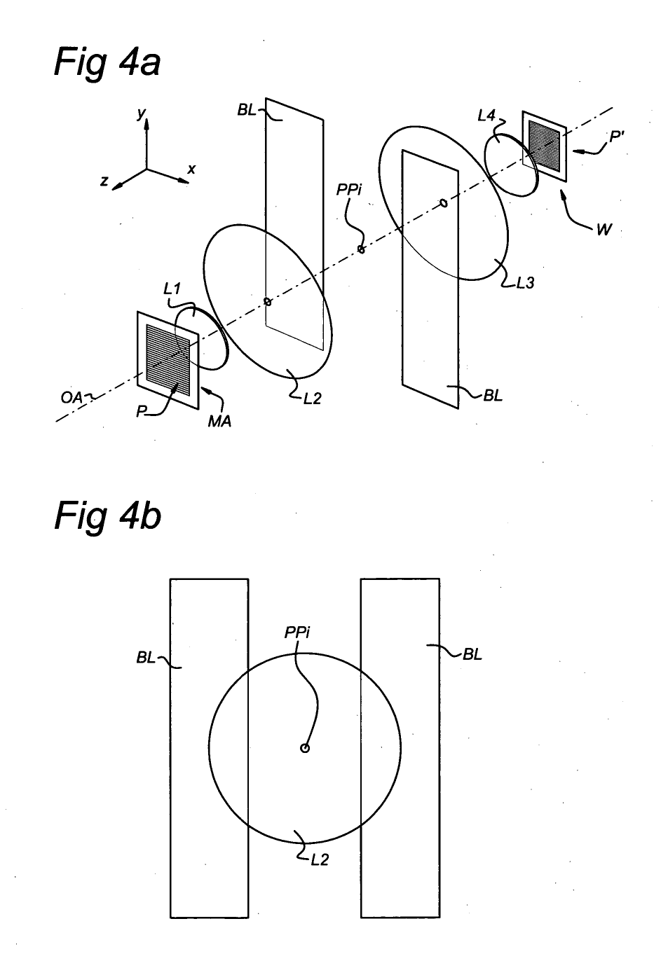

FIG. 3 depicts a schematical view of a projection system PS according to an embodiment of the invention. FIG. 3 depicts four lenses: first lens L1, asymmetrical second lens L2′, asymmetrical third lens L3′ and fourth lens L4, each being positioned along optical axis OA. The projection system PS is arranged to project a pattern P to form a projected pattern P′ on substrate W. The pattern P may be provided on mask MA.

FIG. 3 also depicts pupil plane PP. The intersection of the pupil plane PP with the optical axis OA is indicated in FIG. 3 with PPi. A coordinate system is depicted to indicate x, y and z directions. The z direction coincides with the optical axis OA.

The pattern P is a line pattern including a plurality of lines extending in the x direction, the lines being positioned next to each other in the y direction. It will be understood that in order to successfully project pattern P, the numerical aperture in the y direction NA_{y} needs to be relatively high, while for the x direction a relatively low numerical aperture NAₓ suffices.

In order to get an asymmetrical numerical aperture NA, the lenses in the vicinity of the pupil plane PP are made non-symmetrical, i.e. by providing asymmetrical second lens L2′ and asymmetrical third lens L3′. The differences with the second lens L2 and third lens L3 depicted in FIG. 2 are indicated by the shaded parts. As can be seen in FIG. 3, the dimensions of the asymmetrical second and third lenses L2′, L3′ are larger in the y direction than in the x direction.

It should be appreciated that the size of asymmetrical second and third lenses L2′, L3′ directly influence angle α as present in the formula defining the numerical aperture NA. The angle αₓ in the x direction and the angle α_{y} in the y direction are now different. For the numerical aperture in the x direction the following formula applies: NAₓ=n·sinαₓ and accordingly for the y direction: NA_{y}=n·sinα_{y}. As αₓ<α_{y} (due to the asymmetrical lenses), sin αₓ<sin α_{y} (0°<αₓ<90°; 0°<α_{y}<90°), and thus: NAₓ<Na_{y}.

As a result, the asymmetrical second lens L2′ and the asymmetrical third lens L3′ can be manufactured using less material, and thus more cost-efficiently. Also, these lenses have a space-saving effect, as they take up less space than the second and third lenses L2 and L3 depicted in FIG. 2.

It should be appreciated that other possible optical elements of the projection system PS, such as lenses L1 and L4, may be formed non-circular or asymmetrical, saving costs and/or space. However, first lens L1 and fourth lens L4 are relatively close to the pattern P and the projected pattern P′ respectively. These lenses L1, L4 therefore mainly ‘see’ field information. Changing the outer shape of these lenses may therefore affect the boundaries of the projected field and may result in lost field information. Therefore, lenses of the projection system PS may be formed asymmetrical, but care should be taken not to decrease the size of lenses in such a way that part of the pattern P is not imaged at all, or with a light intensity that is too low.

According to an embodiment, there may be provided an optical system, configured to process a radiation beam along an optical axis, the optical system including at least one optical element, wherein at least one of the optical elements having a first dimension in a first direction and a second dimension in a second direction differing from the first direction, the first direction and the second direction being substantially perpendicular to the optical axis and the first and second values being different. For example, the parts of the optical elements that are not used may be left out.

According to a further embodiment, the optical system may be a projection system, configured to project a pattern imparted to the radiation beam onto a target portion along the optical axis, and wherein the at least one of the optical elements is positioned close to the pattern or the target portion. These optical elements may be field lenses, which mainly ‘see’ field information.

The first and second dimension may be substantially identical in shape with the dimensions of the pattern P and/or the target portion C.

Asymmetrical lenses may be manufactured in different ways. For example, an asymmetrical lens may be manufactured as a state of the art symmetrical lens, from which parts are removed. The removed parts may be used in the production of other lenses. Also, asymmetrical lenses may be manufactured by polishing an asymmetrical piece of lens material. Of course, other methods of manufacturing asymmetrical lenses may be conceived.

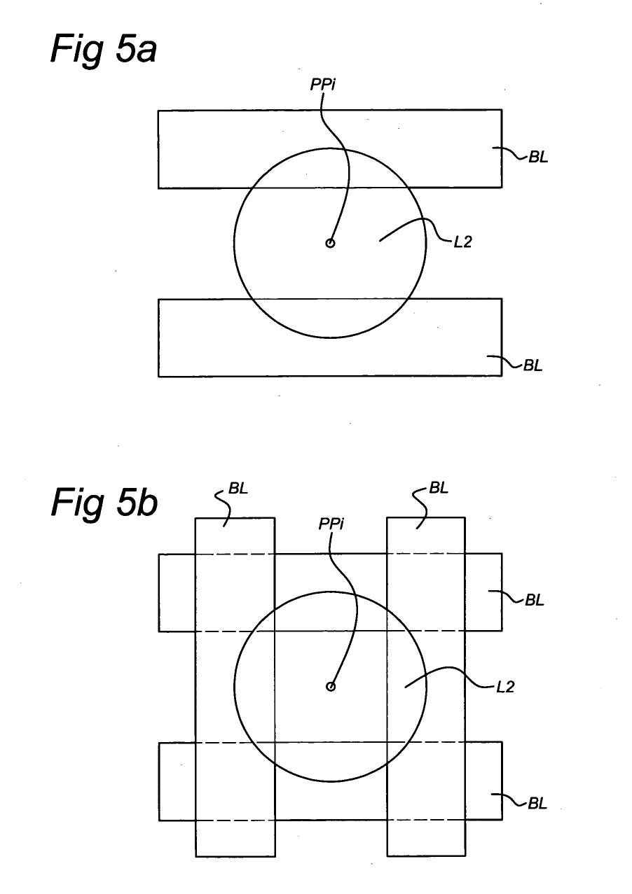

According to a further embodiment, an asymmetrical numerical aperture NA may be obtained by using a rotationally symmetrical projection system PS, as schematically depicted in FIG. 4a, including an asymmetrical diaphragm, for example formed by two blades BL. The blades BL may be positioned in the pupil plane PP. The blades BL are an easy way of obtaining an asymmetrical numerical aperture NA. FIG. 4b schematically depicts a view of the blades BL in the direction of the optical axis OA. The second lens L2 is depicted to show the relative position of the blades BL with respect to the lens L2.

It should be appreciated that an asymmetrical numerical aperture NA enables maximizing the DOF in one direction. It is known that the DOF scales with the numerical aperture: DOF ˜λ/NA². In case a pattern is to be projected, having a small pitch (relatively high numerical aperture NA needed) in a first direction and a large pitch in a second direction (relatively low numerical aperture NA suffices), an asymmetrical numerical aperture NA may be used to maximize the DOF for the large pitch.

Using a diaphragm to create an asymmetrical numerical aperture NA makes it possible to adjust the value of the numerical aperture by adjusting the settings of diaphragm. Therefore, the blades BL may be moveable blades, arranged to move closer to each other or away from each other. This allows adjusting of the asymmetrical numerical aperture. By positioning the blades BL closer to each other, the numerical aperture in the x direction NAₓ may be decreased and by positioning the blades BL further apart, the numerical aperture in the x direction NAₓ may be increased. Also, the blades BL may be positioned so far apart, that the numerical aperture is symmetrical. This allows using the projection system PS in a flexible way, for different kind of purposes.

The blades may for example be positioned in a pupil plane PP, or close to the pupil plane PP.

According to another embodiment, the orientation of the numerical aperture NA may be changed. For example, the projection system PS may be provided with a rotation device RD arranged to rotate the numerical aperture NA about the optical axis OA with respect to the pattern P to be projected. As a result, the orientation of the asymmetrical numerical aperture NA may be adjusted. This allows adjusting the orientation of the asymmetrical aperture NA in dependence on the orientation of the pattern P to be projected.

According to this further embodiment, an asymmetrical aperture NA may be provided according to one of the various ways described in this document.

According to a first alternative, the rotation device RD may be provided to rotate at least one of mask table MT carrying mask MA and substrate table WT carrying substrate W with respect to the projection system PS. According to a second alternative, the rotation device RD may be provided to rotate projection system PS to rotate the asymmetrical numerical aperture NA with respect to mask table MT and the substrate table WT. Also, the rotation device RD may be provided to rotate only part of the projection system PS, i.e. only rotate the asymmetrical elements of the projection system PS.

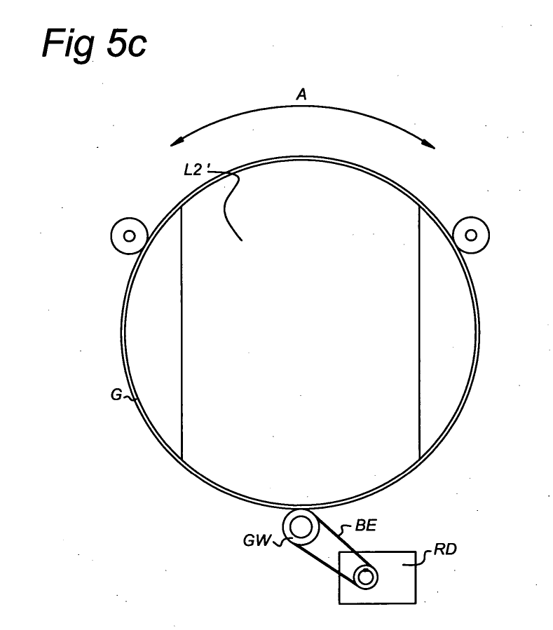

For example, when considering this second alternative in combination with the first embodiment discussed above (see FIG. 3), the rotation device RD may be arranged to rotate second asymmetrical lens L2′ and third asymmetrical lens L3′ about the optical axis OA. FIG. 5c schematically depicts an example of a rotation device RD. The rotation device RD is arranged to control a gear wheel GW to actuate, in this example, second asymmetrical lens L2′, in the direction of arrow A. According to the example depicted in FIG. 5c, the rotation device RD actuates the gear wheel GW using a belt BE. The rotation device RD may be controlled by a main control unit (not shown), of, for example, a lithographic projection apparatus in which the projection system PS is used.

The gear wheel GW actuates a circular gear G, partially formed along the outer edge of the asymmetrical lens L2′, as can be seen in FIG. 5c. The gear wheel GW and the gear G may be toothed gears that engage. However, the gear wheel GW may also drive the gear G using a friction force present between the gear wheel GW and the gear G. Therefore, the gear wheel GW and the gear G may also be rubber wheels.

Of course, many other rotation devices RD and systems to actually perform the rotation may be used. The rotation device RD may also be arranged to control one or more other parts of the projection system PS.

For example, when considering this second alternative in combination with the second embodiment discussed above (see FIG. 4), the rotational device RD may be arranged to rotate the asymmetrical diaphragm including two blades BL, to a position as indicated in FIG. 5a, where FIG. 5a is a view along the optical axis, similar to FIG. 4a.

FIG. 5b shows a further alternative, in which the orientation of the asymmetrical aperture NA may be altered by using a first set of blades BL to form an asymmetrical numerical aperture in the first direction, and a second set of blades BL to form an asymmetrical numerical aperture in the second direction. Further blades may be provided to create asymmetrical numerical apertures in other directions.

According to a further embodiment, when a pattern P on the mask M needs to be projected of which part of the pattern P requires a relatively high numerical aperture NA in a first direction, and of which another part of the pattern P requires a relatively high numerical aperture NA in a second direction, the pattern P may be divided in two patterns. The pattern P may be divided in a first part P1, including the parts of the pattern P requiring a relatively high numerical aperture NA in the first direction, and a second part P2, including the parts of the pattern P requiring a relatively high numerical aperture NA in the second direction. The pattern P may then be projected by first projecting the first part P1, using an asymmetrical aperture NA in a first orientation, having a relatively high numerical aperture NA in the first direction, and after that, rotating the orientation of the asymmetrical numerical aperture NA with respect to the pattern P such that the second part P2 can be projected using an asymmetrical aperture NA in a second orientation, having a relatively high numerical aperture NA in the second direction.

The above may be performed by dividing the pattern P in the first part P1 and the second part P2 by successively illuminating the first part P1 and the second part P2, while the first part P1 and the second part P2 together form mask MA. However, the first part P1 and the second part P2 may also be two separate masks MA. Thus, first and second part P1, P2 may be different parts of the same mask MA, or may be different masks MA. In both cases two (or more) exposures are combined to form an image.

The rotation of the asymmetrical numerical aperture NA may be done in any of the above described ways, such as by rotating the pattern P and the target portion C, rotating the projection system PS or asymmetrical parts of the projection system PS.

According to a variant, the first part P1 may be projected using a first projection system PS, and the second part P2 may be projected using a second projection system PS. Thus, according to this variant, first the first part P1 is projected onto the target portion C on the substrate W. Next, the substrate W is moved to the second projection system PS. This may be done by moving the substrate table WT from a first to a second position. It may also be done by taking the substrate W of the substrate table WT and positioning it on a second substrate table WT, that is positioned relative to the second projection system PS.

According to this variant, the mask MA may also be moved from the first projection system PS to the second projection system PS. However, the mask MA may also be formed by a first part and a second part, where the first part is positioned to be projected by the first projection system PS and the second part of the mask MA is positioned to be projected by the second projection system PS.

According to another embodiment, the numerical aperture NA as described in this application may also be used in a lithographic projection apparatus having a projection system PS not formed by refractive optical elements, but by reflective optical elements, or by a combination of refractive optical elements and reflective optical elements. Such a projection system PS may for example be used in a lithographic projection apparatus using a (E)UV radiation beam B.

In a lithographic projection apparatus using UV or EUV techniques, the numerical aperture as described in this application may be obtained in many ways, such as for example by making changes to the optical elements, as described above or by providing a diaphragm, being formed by a plurality of blades BL, as also described above.

In case the projection system PS is provided with a numerical aperture NA as described here, the illuminator IL may also be adjusted in accordance with the shape of the numerical aperture NA in the projection system PS.

As explained above, a lithographic projection apparatus includes an illumination system (illuminator) IL configured to condition the radiation beam B (e.g. UV radiation or EUV radiation).

The illuminator IL may include an adjuster AD to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator IL may be used to condition the radiation beam, to have a desired uniformity and intensity distribution in its cross-section.

According to an embodiment, the components of the illuminator IL, such as the adjuster AD, the integrator IL and the condenser CO, may be adjusted in accordance with the shape of the numerical aperture NA of the projection system PS.

If, for example, the shape of the numerical aperture NA is as depicted in FIG. 3, the parts of the components of the illuminator IL that are arranged to process parts of the radiation beam B that will not be transmitted by the projection system PS as a consequence of the shape of the numerical aperture NA, can be left out.

These parts may therefore be manufactured in a more cost efficient way, saving material costs, and have a space-saving effect.

According to a further embodiment, a diaphragm to create an asymmetrical numerical aperture NA is provided, including more than two blades. The diaphragm may for example include four blades as depicted in FIG. 5b, but the diaphragm may also include any number of blades BL, positioned around the optical axis OA. The diaphragm may for example include 3, 8, 12, 16, 25 blades BL or any other number of blades BL. The number of blades BL may be increased to better approach a desired shape of the numerical aperture NA, such as an ellipse. The number of blades BL may be an even number or an odd number.

If, for example, 8 blades BL are provided, the numerical aperture NA may be given an octagonal shape. If for example 25 blades BL are provided, the numerical aperture NA may be given a shape that comes close to an elliptical shape. This way, the numerical aperture NA may be given all kinds of shapes, suitable for different kinds of use.

In general, based on this description, numerical apertures NA may be provided having all kinds of shapes that are not substantially circular. Of course, such non circular shaped numerical aperture NA may have symmetrical characteristics.

It should be appreciated that a substrate W, produced according to one of the embodiments described above, may include a pattern formed on its surface, having different levels of accuracy in different directions. The patterns formed on the surface of the substrate W may include a pattern that is relatively ‘sharp’ in a first direction, corresponding with the direction of the relatively high numerical aperture of the asymmetrical numerical aperture, and is less ‘sharp’ in a second direction. The term ‘sharp’ is here used is to indicate that the transitions between different lines in the pattern in the first direction are well-defined transition lines, in contrast to less well-defined transition lines in a second direction, having more blurry transitions.

It should be appreciated that the above embodiments may very well be used in any kind of lithographic projection apparatus, for example, a lithographic projection apparatus using immersion techniques or a lithographic projection apparatus using EUV. Also, the invention as described above may also be used in any kind of projection apparatus, besides lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. It should be appreciated that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it should be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. An optical system configured to process a radiation beam along an optical axis, the optical system comprising an optical element, the optical system defining a numerical aperture, the numerical aperture being a measure of the ability of the optical system to gather and focus light, wherein the numerical aperture has a first value in a first direction and a second value in a second direction differing from the first direction, the first direction and the second direction being substantially perpendicular to the optical axis, and the first and second values being different.

2. An optical system according to claim 1, wherein the optical system is a projection system configured to project a pattern imparted to the radiation beam onto a target along the optical axis.

3. An optical system according to claim 11, wherein the optical system is an illumination system configured to condition the radiation beam.

4. An optical system according to claim 1, wherein the optical element is a refractive optical element, a reflective optical element, an adjuster, an integrator, a condenser, or any combination thereof.

5. An optical system according to claim 1, wherein the optical element is formed to form the numerical aperture.

6. An optical system according to claim 2, wherein the projection system further comprises a diaphragm to form the numerical aperture.

7. An optical system according to claim 6, wherein the diaphragm is positioned in a pupil plane of the optical system.

8. An optical system according to claim 6, wherein the diaphragm is formed by a plurality of blades.

9. An optical system according to claim 1, wherein the optical system further comprises a rotation device arranged to rotate at least part of the optical system about the optical axis in order to rotate the numerical aperture.

10. An optical system according to claim 9, wherein the rotation device is arranged to rotate the numerical aperture by rotating the optical element.

11. An optical system according to claim 9, wherein the optical system is a projection system configured to project a pattern imparted to the radiation beam onto a target along the optical axis and the projection system further comprises a diaphragm to form the numerical aperture and the rotation device is arranged to rotate the numerical aperture by rotating the diaphragm.

12. An optical system according to claim 9, wherein the rotation device is configured to control a gear wheel, the gear wheel being configured to engage a gear that is connected to the at least part of the optical system to be rotated.

13. A lithographic apparatus, comprising:
an illumination system configured to condition a radiation beam;
a support configured to support a patterning device, the patterning device being configured to impart the radiation beam with a pattern in its cross-section to form a patterned radiation beam;
a substrate table configured to hold a substrate; and
a projection system configured to project the patterned radiation beam onto a target portion of the substrate, wherein the projection system is an optical system being configured to process the radiation beam along an optical axis, the optical system comprising an optical element, the optical system defining a numerical aperture, the numerical aperture being a measure of the ability of the optical system to gather and focus light, the numerical aperture has a first value in a first direction and a second value in a second direction differing from the first direction, the first direction and the second direction being substantially perpendicular to the optical axis, and the first and second values being different.

14. A lithographic apparatus, comprising:
an illumination system configured to condition a radiation beam;
a support configured to support a patterning device, the patterning device being configured to impart the radiation beam with a pattern in its cross-section to form a patterned radiation beam;
a substrate table configured to hold a substrate; and
a projection system configured to project the patterned radiation beam onto a target portion of the substrate, wherein the illumination system is an optical system being configured to process the radiation beam along an optical axis, the optical system comprising an optical element, the optical system defining a numerical aperture, the numerical aperture being a measure of the ability of the optical system to gather and focus light, the numerical aperture has a first value in a first direction and a second value in a second direction differing from the first direction, the first direction and the second direction being substantially perpendicular to the optical axis, and the first and second values being different.

15. A lithographic projection apparatus arranged to project a pattern from a patterning device onto a substrate, wherein the lithographic projection apparatus comprises an optical system being configured to process a radiation beam along an optical axis, the optical system comprising an optical element, the optical system defining a numerical aperture, the numerical aperture being a measure of the ability of the optical system to gather and focus light, the numerical aperture has a first value in a first direction and a second value in a second direction differing from the first direction, the first direction and the second direction being substantially perpendicular to the optical axis, and the first and second values being different.

16. An apparatus comprising an optical system being configured to process a radiation beam along an optical axis, the optical system comprising an optical element, the optical system defining a numerical aperture, the numerical aperture being a measure of the ability of the optical system to gather and focus light, wherein the numerical aperture has a first value in a first direction and a second value in a second direction differing from the first direction, the first direction and the second direction being substantially perpendicular to the optical axis, and the first and second values being different.

17. A method for projecting a pattern onto a target, comprising:
providing a beam of radiation;
patterning the beam of radiation;
projecting the patterned beam of radiation onto the target using a projection system having an optical axis, the projection system comprising an optical element and the projection system defining a numerical aperture, the numerical aperture being a measure of the ability of the projection system to gather and focus light and having a first value in a first direction and a second value in a second direction, the second direction differing from the first direction, the first direction and the second direction being substantially perpendicular to the optical axis, and the first and second values being different.

18. A method for projecting a pattern onto a target, comprising:
providing a beam of radiation along an optical axis using an illuminator, the illuminator comprising an optical element and the illuminator defining a numerical aperture, the numerical aperture being a measure of the ability of the illuminator to gather and focus light and having a first value in a first direction and a second value in a second direction, the second direction differing from the first direction, the first direction and the second direction being substantially perpendicular to the optical axis, and the first and second values being different;
patterning the beam of radiation;
projecting the patterned beam onto the target.

19. A method according to claim 17, wherein the pattern comprises a first part and a second part and the method further comprises:
projecting the first part of the pattern onto the target;
rotating the numerical aperture about the optical axis over a predetermined angle; and
projecting the second part of the pattern onto the target object.

20. A device manufactured according to the method of claim 17.

21. An optical system configured to process a radiation beam along an optical axis, the optical system comprising an optical element, wherein the optical element has a first dimension in a first direction and a second dimension in a second direction differing from the first direction, the first direction and the second direction being substantially perpendicular to the optical axis.

22. An optical system according to claim 21, wherein the optical system is a projection system configured to project a pattern imparted to the radiation beam onto a target along the optical axis, and the optical element is positioned close to the pattern or the target.
